(19) United States
(12) Patent Application Publication
(10) Pub. No.: US 2015/0120198 A1
(43) Pub. Date: Apr. 30, 2015

(54) SYSTEM AND METHOD FOR ANALYZING MICROSEISMIC EVENTS USING CLUSTERS

(71) Applicant: CGG SERVICES SA, Massy Cedex (FR)

(72) Inventors: Estelle REBEL, VERRIERES-LE-BUISSON (FR); Julien MEUNIER, Paris (FR)

(73) Assignee: CGG SERVICES SA, Massy Cedex (FR)

(21) Appl. No.: 14/138,301

(22) Filed: Dec. 23, 2013

(30) Foreign Application Priority Data
Oct. 31, 2013 (FR) 1360739

(51) Int. Cl. G01V 1/30

(52) U.S. Cl. CPC G01V 1/30
USPC 702/14

(57) ABSTRACT

According to an embodiment, a method for analyzing microseismic events associated with hydraulic fracturing detects a new microseismic event and assigns it to a cluster of other events having similar characteristics. Cluster characteristic(s), e.g., average event(s), average source mechanisms, and/or average locations, are updated and used to characterize a future microseismic events.

### TECHNICAL FIELD

The present invention relates generally to the detection of microseismic events and, more specifically, to systems and methods for modeling future microseismic event locations and source mechanisms based on a review and analysis of previously detected and characterized related microseismic events.

### BACKGROUND

A widely used technique for searching for oil or gas is the seismic exploration of subsurface geophysical structures. Reflection seismology is a method of geophysical exploration to determine the properties of a portion of a subsurface layer in the earth, which information is especially helpful in the oil and gas industry. The seismic exploration process consists of generating seismic waves (i.e., sound waves) directed toward the subsurface area, gathering data on reflections of the generated seismic waves at interfaces between layers of the subsurface, and analyzing the data to generate a profile (image) of the geophysical structure, i.e., the layers of the investigated subsurface. This type of seismic exploration can be used both on the subsurface of land areas and for exploring the subsurface of the ocean floor.

Generally, in the field of oil and gas exploration and recovery, analysis of seismic data obtained through seismic surveys can provide information about the physical parameters of subterranean rock formations. Conventional surface seismic surveys record compressional, or P-waves. Multicomponent seismic surveys record both P-waves and shear, or S-waves. Seismic data processing methods include azimuthal velocity correction and amplitude versus offset (AVO) analysis and inversion, amplitude versus offset and azimuth (AVOA or AVAZ—Amplitude Versus Angle and Azimuth) analysis and inversion of conventional three dimensional (3D) seismic data, and birefringence analysis of multicomponent 3D seismic data. The analyzed seismic data can provide useful information regarding the characteristics and parameters of the subterranean formation such as rock strength: Young's modulus and Poisson's ratio, and in-situ principal stress directions and magnitudes: one vertical stress, σᵥ, and two horizontal stresses, σ_{Hmax} and σₕₘᵢₙ. Further, seismic detection of subsurface fractures has important applications in the study of unconventional rock formations such as shale plays, tight gas sands and coal bed methane, as well as carbonates, where the subterranean formations are naturally fractured reservoirs.

Information concerning these characteristics and parameters are often important in a variety of fields such as underground transportation systems, foundations of major structures, cavities for storage of liquids, gases or solids, and in prediction of earthquakes. In oil and gas exploration, the information is important for determining optimal locations and orientations of vertical, inclined, and horizontal wells, minimizing wellbore instability, and formation break-out. Also, these characteristics are useful to optimize the operating parameters of a commonly utilized technique for stimulating the production of hydrocarbons by applying hydraulic pressure on the formation from the wellbore.

One such technique is commonly referred to as hydro-fracturing. Hydro-fracturing is the process wherein fluid is injected into the target area of interest to create distinct fractures, in order to link to existing fractures to create permeability. This is done to extract in situ fluids, such as oil and gas. However, it has been noted that shear failures can occur with hydro-fracturing operations, as the fluid leaks off into existing fractures.

Microseismic monitoring, as its name implies, is the monitoring of relatively small seismic events, such as those typically produced by industrial activities including hydro-fracturing and/or mining. The exact location where either a new rock fracture occurred, or an existing fracture was activated, is referred to as the event location. Analysis of P and S waves can be used to determine the distance between the event location and the sensor(s) that receive the waves. The time depends on the velocity of the medium through which the waves are traveling. Source mechanisms, or fault place solutions, are defined as the fault orientation, the displacement and stress release patterns, and the dynamic process of seismic wave generation. Alternatively, source mechanisms can be defined as the exact orientation and sense of slip of the fault rupture that generates a seismic event. Knowledge of the location of microseismic events, and their source mechanism, can be useful in tracking the location of fluids in a reservoir as well as to investigate the state of stress in the reservoir.

Accordingly, it would be desirable to provide methods, modes and systems for the accurate analysis of microseismic events in order to more precisely determine their origins and characteristics.

### SUMMARY

It is therefore a general aspect of the invention to provide a method for analysing microseismic events that will obviate or minimize problems of the type previously described.

According to a first aspect of the present invention, a method for analyzing microseismic events associated with hydraulic fracturing, includes the steps of detecting a new microseismic event, assigning the new microseismic event to a cluster, determining a location of the new microseismic event relative to other microseismic events in the cluster, translating an event location of each microseismic event in the cluster to a common location, determining an average event in the cluster; determining an absolute location of the average event, determining a source mechanism of the average event; and using the absolute location and the source mechanism of the average event to characterize a future microseismic event assigned to the cluster.

According to another aspect, a method for analyzing microseismic events associated with hydraulic fracturing includes the steps of: detecting a new microseismic event, assigning the new microseismic event to a cluster, determining an average event in the cluster by determining a location of the new microseismic event relative to other microseismic events in the cluster and translating an event location of each microseismic event in the cluster to a common location, and using the average event to characterize a future microseismic event assigned to the cluster.

According to another aspect, a method for analyzing microseismic events associated with hydraulic fracturing includes the steps of detecting a new microseismic event, assigning the new microseismic event to a cluster, determining an average event in the cluster, and using the average event to characterize a next detected microseismic event.

### BRIEF DESCRIPTION OF THE DRAWINGS

The above and other objects and features of the present general inventive concept will become apparent and more readily appreciated from the following description of the embodiments with reference to the following figures, wherein like reference numerals refer to like parts throughout the various figures unless otherwise specified, and wherein:

FIG. 1 illustrates a side view of a data collection system for the determination and characterization of microseismic events using a cluster of arrays according to an embodiment;

FIG. 2 illustrates a top view of the data collection system shown in FIG. 1;

FIG. 3 illustrates a flow chart of a method for determining an average microseismic event, an absolute position of the average microseismic event and a source mechanism of the average event for use in modeling microseismic events and microseismic event clusters according to an embodiment;

FIGS. 4A-4H illustrate a series of displays representing results of a cross correlation between a newly detected event with a previously detected or reference event to determine placement of the newly detected event into a new or known cluster of events according to an embodiment;

FIGS. 5A-H graphically illustrate a process for the evaluation of a new event's location to the location of other events in a cluster according to an embodiment;

FIG. 6A illustrates a graph of a new event, and FIG. 6B illustrates a graph of an average event in a cluster according to an embodiment;

FIG. 7A illustrates a conversion of a plurality of event source mechanisms to an average source mechanism according to an embodiment, and FIG. 7B illustrates a conversion of a plurality of event source mechanisms to an explosion source mechanism according to an embodiment;

FIG. 8 illustrates a graph of an actual absolute position of the average event, and an estimated absolute position as determined by a method according to an embodiment; and

FIG. 9 illustrates a seismic data acquisition system which can be used to implement methods for modeling microseismic events and microseismic event clusters according to an embodiment.

### DETAILED DESCRIPTION

The inventive concept is described more fully hereinafter with reference to the accompanying drawings, in which embodiments of the inventive concept are shown. In the drawings, the size and relative sizes of layers and regions may be exaggerated for clarity. Like numbers refer to like elements throughout. This inventive concept may, however, be embodied in many different forms and should not be construed as limited to the embodiments set forth herein. Rather, these embodiments are provided so that this disclosure will be complete, and will convey the scope of the inventive concept to those skilled in the art. The scope of the invention is therefore defined by the appended claims. The following embodiments are discussed, for simplicity, with regard to the terminology and structure of a land based seismic signal generation, detection, and seismic signal data processing system. However, the embodiments to be discussed next are not limited to these systems but may be applied to other seismic systems that collect data from multiple receivers.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” on “in an embodiment” in various places throughout the specification is not necessarily referring to the same embodiment. Further, the particular feature, structures, or characteristics may be combined in any suitable manner in one or more embodiments.

Used throughout the specification are several acronyms, the meaning of which are provided as follows: universal serial bus (USB); high speed interchip (HSIC); consumer electronics (CE); personal computer (PC); system-on-chip (SoC); USB transceiver macro-cell interface (UMTI+); UTMI+ low pin count interface (ULPI); physical transceiver (PHY); printed circuit board (PCB); center of gravity (COG); global positioning system (GPS); and geographical area of interest (GAI).

Microseismic reservoir monitoring consists of the detection and analysis of low amplitude seismic events created by production related rock motion in the reservoir area. One example of a production related event is a fracture opening that occurs during hydraulic fracturation operations. Fracturation is the process of introducing high pressure fluid, usually water but sometimes oil, into the ground along a fault line to create tensile pressure to cause the fault to expand. The expanding fault allows subterranean oil and/or gas located below the fault to rise through the now-expanded fault and be captured. The origination of microseismic events are known well enough to those of skill in the art that a more detailed explanation is neither necessary nor desired for the dual purposes of clarity and brevity, and thus have been omitted.

It is known by those of skill in the art that to improve reservoir management, monitoring of microseismic events caused by hydro-fracturing should be performed in order to obtain information that can improve the extraction of the hydrocarbon. For example, such information can include knowledge of the fluid fronts, the location of active faults, how shear movements are occurring, and knowledge about the compaction of reservoirs. Having information concerning one or more of these items will assist in optimizing production, and substantially mitigate geomechanical risk.

It is further known to those of skill in the art that successive events that are linked to the same fracture or fracture system often show some common properties. For example, these properties include: origination from the same or close locations (referred to as an “event location property”); and corresponding source mechanisms that are substantially the same or similar (referred to as a “source mechanism property”). According to an embodiment, systems and methods take advantage of event location and source mechanism properties to provide more sensitive detection, more accurate positioning, and increased precision about the determination of the source mechanism. According to an embodiment, a set of microseismic events that share similarities in event location and source mechanism will be referred to herein as an “event cluster.” Following acquisition of the energy of microseismic waves, and evaluation of their properties according to an embodiment, the systems and methods disclosed herein will create one or more event clusters based on the aforementioned properties. Once the one or more event clusters have been generated, a “master event” or “average event” can be determined for each cluster, which is defined as an optimized sum of all events of the cluster. The manner in which the average events are determined is discussed in greater detail below. The average events will then be used to characterize newly detected events in a way that makes microseismic event monitoring more accurate, among other things.

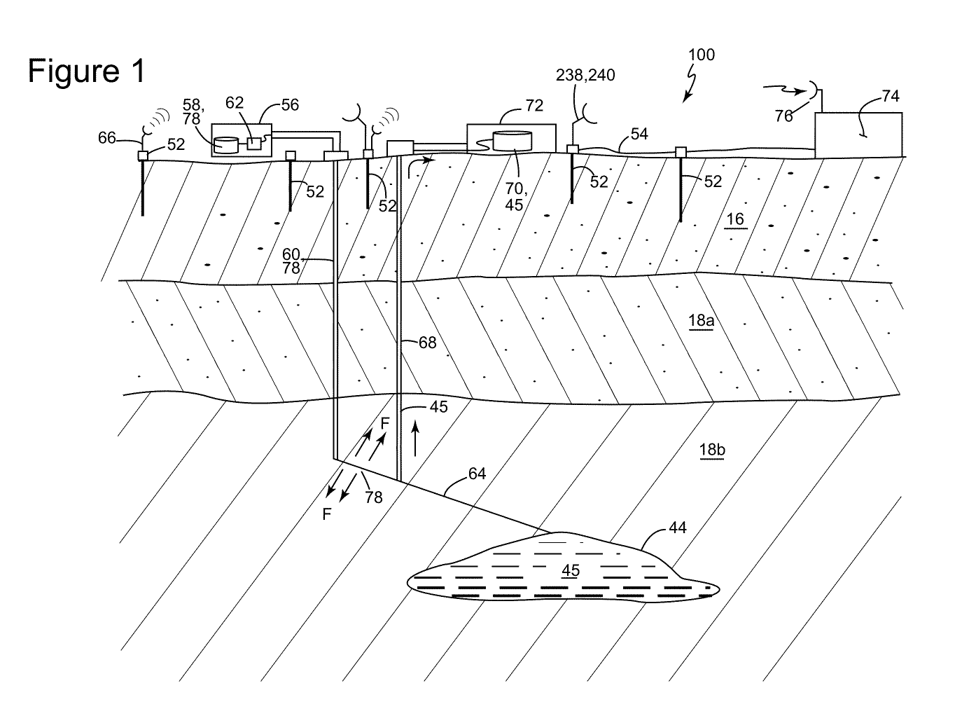

Prior to discussing such embodiments, fracturation operations system 100 according to an embodiment is shown in FIG. 1 for context, and includes, among other items, fluid storage/pressurization unit 56 that stores fracturation fluid (fluid) 78 prior to pressurization and introduction into fracturation fluid transfer pipe (fluid transfer pipe) 60. Fluid storage/pressurization unit 56 includes fracturation fluid tank (tank) 58, and fracturation fluid pump (pump) 62. Pump 62 pressurizes fluid 78 for transfer through fluid transfer pipe 60 to fracture 64. The introduction of pressurized fluid 78 creates tensile forces in solid earth/rock layer 18b around fracture 64, causing it to separate.

Separation of fracture 64 allows the flow of hydrocarbons 45 from hydrocarbon deposit 44 into fracture 64 and out through hydrocarbon extraction pipe 68. Extraction pipe 68 is connected to, by way of example, an extraction pump that then transfers hydrocarbons 45 to hydrocarbon capture facility 72, within which is hydrocarbon storage tank 70. As those of ordinary skill in the art can appreciate, the above is a greatly simplified discussion of a fracturation operation. For example, there can and often are numerous sites at which pressurized fluid is introduced into the subsurface area of interest, and those subsurface areas can include many different types of materials, including shale, sand, solid rock, among other types.

System 100 according to an embodiment further includes data processing system 74, and a plurality of microseismic sensors 52. Data processing system 74 can be located at the oil field, to permit faster analysis and decision making, or can be located remotely from the oil field, e.g., as part of a data center. Microseismic sensors 52 are designed with sufficient sensitivity to detect relatively small geological disturbances that will be caused by fracturation operations. Microseismic sensors 52 are also designed to be protected from the relatively larger signals that would be caused by significantly greater magnitude geological disturbances such as earthquakes. Each microseismic sensor 52 includes a mechanism for communications to data processing system 74. Such communications systems can include communications cables 54, and can also include a wireless means of communications 66, such as is shown in FIG. 1.

Each microseismic sensor 52 will also typically include microseismic signal data acquisition and digitization circuitry, modulation and transmission circuitry, and may also include a global positioning system (GPS) transceiver and antenna 238/240 to add time data, among other types of data, to the microseismic data. All the acquired data can then be transmitted wirelessly to data processing system 74 (which includes its own communications system 76 (represented in FIG. 1 by an antenna) and which can also include a GPS receiver)) via communications system 66 (represented by the antenna) or via wired connections (cable 54), depending on cost constraints and distances. Regardless of the means of communications, which are known to those of skill in the art, the microseismic data collected by microseismic sensors 52 will be collected by data processing system 74 and processed therein, as described in greater detail below, to provide enhanced determination of the location and characterization of the microseismic events causing fracturation. Such acquired information can improve the performance of hydrocarbon extraction by making the process more efficient and effective, as also will be described in further detail below.

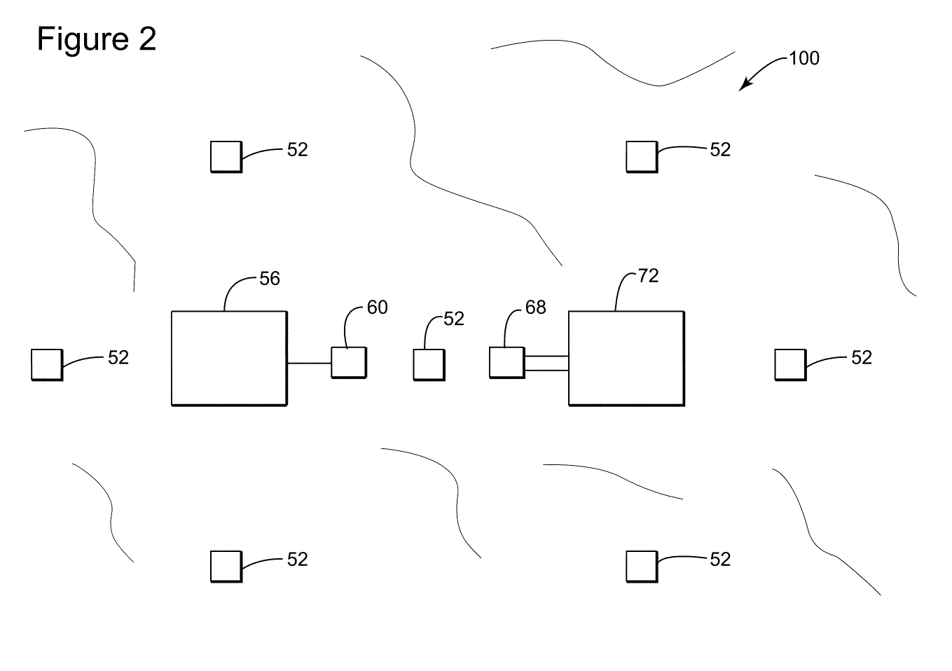

As described above, microseismic sensors 52 are deployed in the vicinity of hydrocarbon deposit 44. To better see an exemplary placement of sensors 52, a partial top view of the system 100 is shown in FIG. 2. One manner of operation is to deploy a plurality of microseismic sensors 52 in observation well(s). Another way is to deploy microseismic sensors 52 at or close to the earth surface. According to an exemplary embodiment, and as mentioned earlier, methods described herein analyzes microseismic events recorded during fracturation operations using one or more clusters of events.

Hydraulic fracturing causes microseismic events, which, in turn, generate (micro)seismic waves propagating in substantially all directions from the location of the event. Microseismic sensors 52 can be placed, or deployed, within the medium to capture the microseismic waves. Microseismic events occur when the medium has reached its pressure limit, i.e., when the forces applied by the pressurized fluid 78 to the surrounding medium, as shown in FIG. 1 solid earth/rock layer 18b, exceeds the strength of the solid earth/rock layer 18b to stay together in the vicinity of fracture 64. The term “solid”, as used in this context and as will be understood by those of skill in the art, does not connote a homogeneous uninterrupted structure without faults, fractures 64, or cracks; instead, it means that the matter that makes up the layer 18b, while substantially whole, can include those fractures 64, faults, fissures, and so on that can be exploited by the system and method according to an embodiment to find and extract hydrocarbons deposits 44 deposited therein, often at great depths.

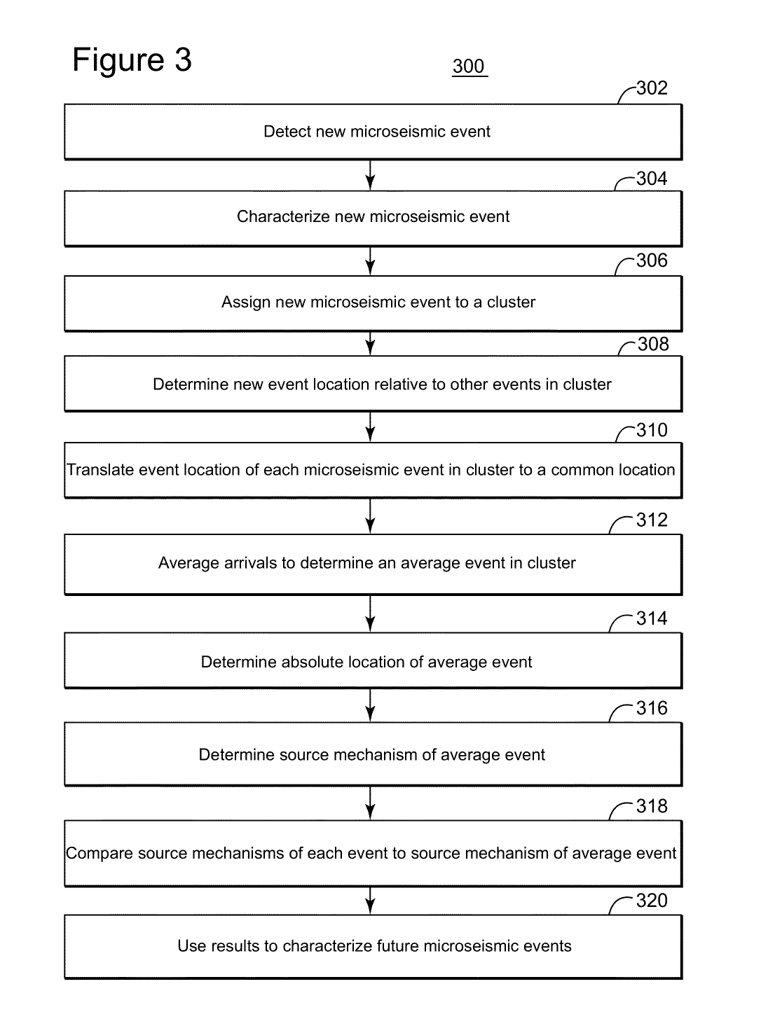

Attention is now directed to FIG. 3 that illustrates a flow chart of method 300 for analyzing microseismic events, e.g., to determine the absolute position of the average microseismic event and average event source mechanism, for use in modeling new microseismic events and microseismic event clusters according to an embodiment. The steps of method 300, as described in detail below, provide an average or master event (with its characteristics of event location and source mechanism) for one or more clusters, which can then be used in evaluating new events as they occur and are received and stored in digital form.

Method 300 begins with step 302 in which a new microseismic event is detected by a plurality of sensors or receivers 52. Each of the sensors 52 collects energy data of the seismic waveforms associated with the new event, digitizes the energy data, and sends it to data processing system 74. Since fractures 64 can be substantially lengthy, and a significant amount of pressurized fluid can be introduced over some time, one or more microseismic events can and probably will occur over the length of fracture 64. In steps 304 and 306, method 300 characterizes the new microseismic event by event location and source mechanism and assigns the new event to a cluster. That is, method 300, through use of data processing system 74, compares the received energy of the new event (which energy includes both location information associated with the new event (i.e., its position underground, the “event location”), and information about its source mechanism) with energy associated with the different clusters that have previously been established to characterize the new event.

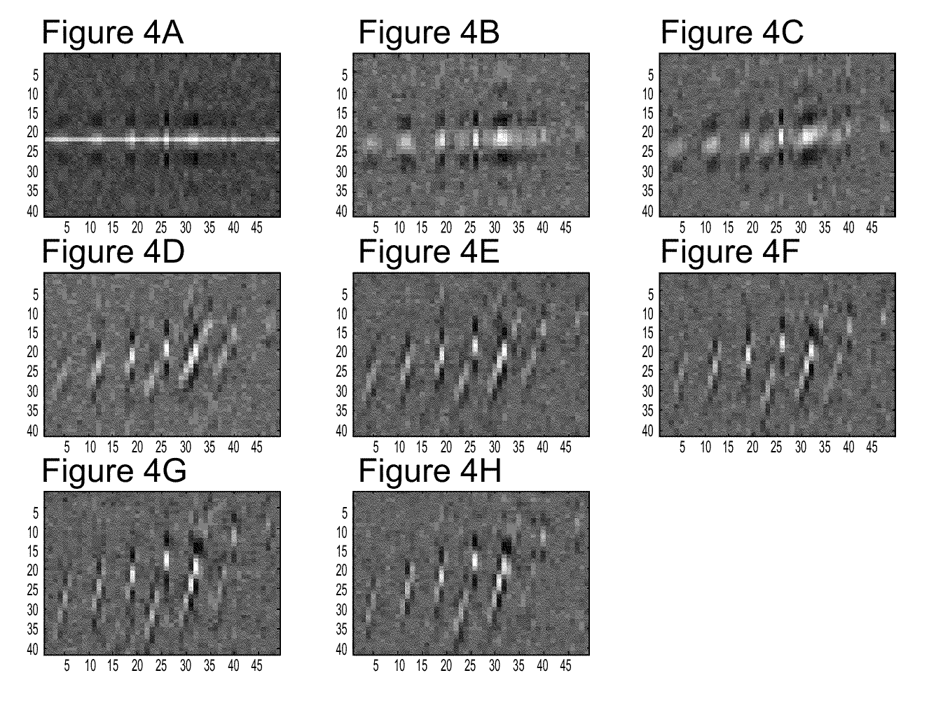

To better understand this characterization portion of method 300, consider FIGS. 4A-4H. Therein, the energy associated with the new event is cross correlated with energy representing a known reference event or an average event associated with a different clusters. Each of FIGS. 4A-4H thus graphically represent the results of a different cross correlation for each existing cluster; the better the results, the more similar are the two events (i.e., the new event and the average event) such that a more accurate representation can be made of the new microseismic event. For example, in FIG. 4A, the cross correlation result is such that a very good match exists between the new event and the reference or average event. In FIGS. 4B through 4H, the results become progressively worse, and as such represent a divergence of the characteristics of the new event to the reference or average event. Thus, the cluster the reference or average event that FIG. 4A represents will be the characteristics or cluster set that the new event is assigned to. According to an embodiment, the new event will be assigned to an existing cluster set if the cross correlation is such that the event location of the new event and that of the reference or average event are substantially the same, as generally indicated by step 306 and further described below.

As those of skill in the art can appreciate at time zero, e.g., when method 300 is being initialized, there may not be a known reference event or average event to use in characterizing the newly detected microseismic event. In such circumstances, a reference or average event can be developed mathematically by modeling the region, and/or by using information from other areas or locations where similar geographical features exist. It may also be the case that the new event is sufficiently new or different such that it will not match any known or reference event. In these circumstances, a new cluster can be established and the new microseismic event assigned thereto.

Returning now to FIG. 3, step 306 can be performed, for example, by determining an average correlation coefficient as defined by the following formula:

$$CC ( Ei , Ej ) = max [ \frac{1}{N} {\sum }_{receivers} \frac{( {\sum }_{n} {S}_{i} ( n ) {S}_{j} ( n + t ) )}{\sqrt{( {\sum }_{n} {S}_{i} ( n ) {S}_{i} ( n + t ) ) ( {\sum }_{n} {S}_{j} ( n ) {S}_{j} ( n + t ) )}} ] \qquad ( 1 )$$

The variables used in equation (1) will now be explained. In an embodiment of step 306 a high threshold th1 and a low threshold th2 are defined. When a new event Ei is detected it is compared to the events Ej of existing clusters using the formula given by equation (1). In this formula, Sᵢ (t) and Sⱼ (t) are the waveforms recorded for the microseismic events Ei and Ej, respectively, and N is the number of receivers. If the correlation coefficient (CC) for the new event as compared with the existing events exceeds th1, then that new event is assigned to the cluster providing the highest correlation coefficient. On the other hand, if the correlation coefficient is less than th2, then a new cluster is defined and the new event is assigned to this new cluster.

In step 308, method 300 determines the new event's location relative to the locations of other events in the cluster. In this evaluation, method 300 evaluates the new event location with the other event locations of the remaining events in the event cluster using, according to an embodiment, a grid search method described below. According to another embodiment, other techniques for evaluating event locations include a differential method based on the multi-dimensional Taylor formula.

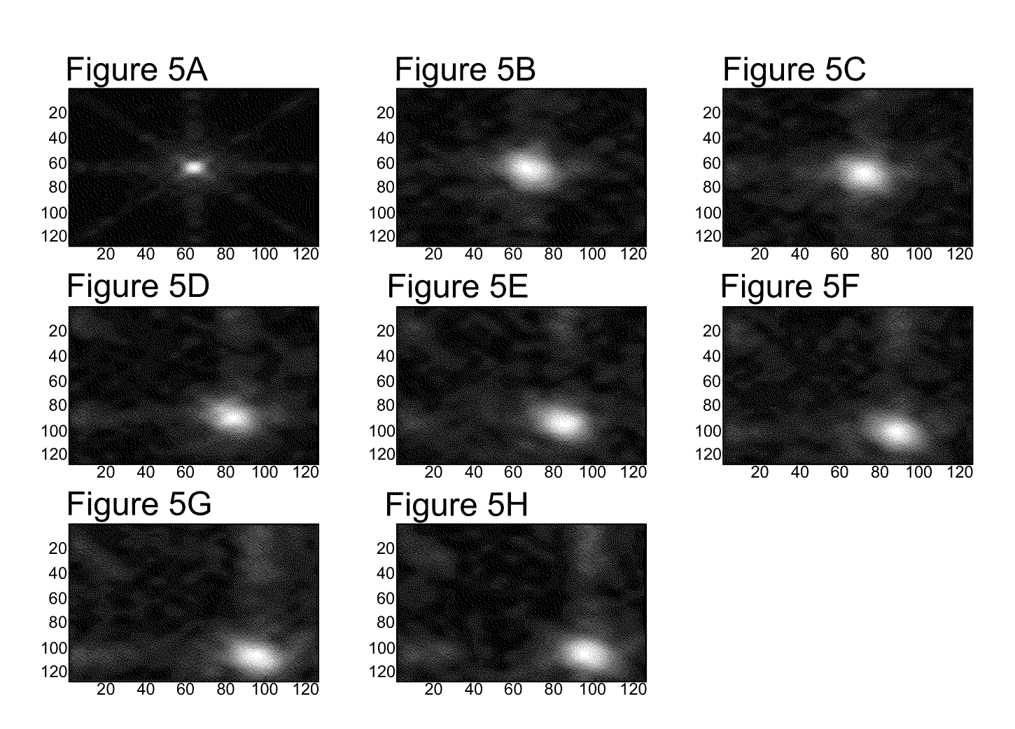

FIGS. 5A-H graphically illustrate a grid search process for the evaluation of a new event location relative to each event location of the events assigned to a cluster according to an embodiment. According to this embodiment, the purpose of performing the evaluations as shown in FIGS. 5A-5H is to try and determine the best or closest event location of the new event to known events of the event cluster. This is accomplished by selecting a grid of possible relative locations centered on the actual location and, for each grid point, calculating the correlation coefficient using equation (1) between the first event and a second event after applying to the first event a time shift equal to the difference in travel time from its actual location (center of the grid) to the receivers and from each grid point to the receivers. When the correlation coefficient (CC) amplitude is at its maximum, the probability for the first event to be located at a distance from the second event given by the position of the corresponding grid point is highest.

In the example of FIG. 5, it can be seen that FIG. 5A shows the highest probability in the center of the grid. Event 1 and event 2 are essentially collocated; since from FIGS. 5B through 5H it can be seen that the event locations become more and more distant. The advantage of relative positioning is a significantly higher precision in the relative positions of the various events in a same cluster. This property enables the averaging of these events to produce a new average event with a higher signal-to-noise ratio which can be positioned and characterized with a higher precision and subsequently used to detect new events with a higher sensitivity and position these events with a higher relative precision. The event location of the new event can be compared to an average location of the events in the cluster to which the new event was assigned.

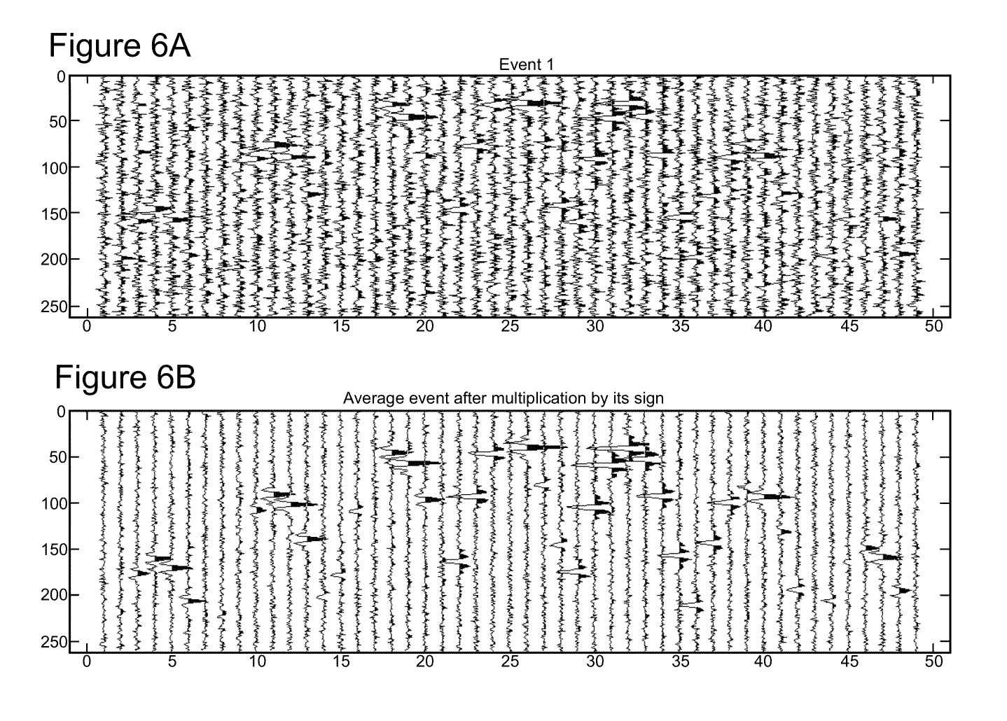

This average event location is obtained in two steps in this embodiment. First, in step 310, an average location is defined and a time shift equal to the difference in travel time from the estimated location and from the average location is applied to each event. After this step, arrivals at each receiver from each event in the cluster occur at the same time. Step 312 averages these arrivals to form the average event. The average location in step 310 can, for example, be a straight average of the relative coordinates found in step 308 or a weighted average using a function of signal amplitude, of noise (e.g., the inverse of noise energy) or of S/N ratio as a weight. Likewise, in step 312, averaging of the shifted event can be a straight or a weighted averaging. The benefits of using averages in this way can be seen by reviewing FIGS. 6A and 6B. For example, FIG. 6A represents, for example, the arrivals of one individual event on the various receivers. The low signal-to-noise ratio makes time and amplitude picking difficult and unsure. Compare this to FIG. 6B which represents, for example, the average event obtained by steps 310 and 312. Using these techniques, selecting time and amplitude of the average event becomes more accurate.

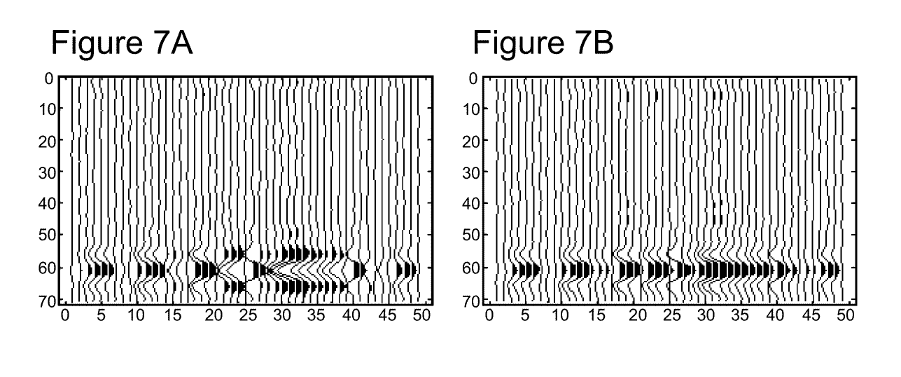

Once the average event is obtained, its absolute location is evaluated in step 314 using, for instance, the method described in French Patent 2946153, the disclosure of which is incorporated here by reference. The advantage of conducting this evaluation on an average event is the higher S/N ratio of the data input in the process and the likely higher precision of the output coordinates. This can be observed in FIG. 7A obtained after shifting the average event in FIG. 6B at its estimated absolute location.

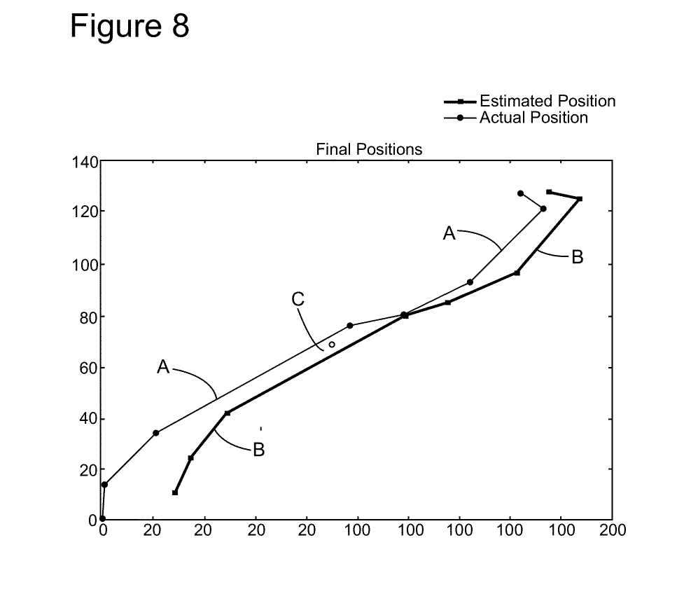

Step 314 can also be described with respect to FIG. 8. As shown in FIG. 8 a graph is made of the relative positions of each of the events in a first cluster, with respect to the determined average position that was determined in the previous steps. In FIG. 8, line A represents the actual event locations or positions of each of set of events in a first cluster (seven events); and line B represents the estimated locations or positions of each of the seven events of the first cluster. Point C is the determined average event, as determined by method 300 as well as the estimated positions of the seven events of the first cluster. As those of skill in the art can appreciate, the farther from the average each event is, whether estimated or actual, the worse the relative position is of the event.

Likewise, in step 316 the source mechanism of the average event is evaluated using conventional methods, however with the advantage of a better S/N ratio. FIG. 7B represents the flattened arrival of the average event after correcting for the source mechanism.

As briefly discussed above, it is possible that in a single event cluster there can be events with slightly different source mechanisms. For example, it is well known that events can be generated by a fault in the earth's crust that slips. The slip can occur over a significant distance, and because of that, the orientation of the fault line can change over distance, causing different source mechanisms as well as locations for the different events. Although substantially the same, the source mechanisms for the different events can be just different enough to be detected. Due to low signal-to-noise ratio, individual estimation of the source mechanism on each individual event would result in a significant dispersion of the resulting mechanisms. Rather, in step 318, instead of using the (noisy) amplitude measured on each receiver for a given event, the ratio between the correlation of event arrival with the corresponding average arrival and the autocorrelation of the average arrival will be used. This ratio will be determined with a significantly higher signal-to-noise ratio (in particular the receiver term will be eliminated). When the source mechanism does not change, this ratio will remain constant.

The final step of method 300, according to an embodiment is the use of the newly determined average event, with its event location and source mechanism, as the new baseline or reference event for use in method 300 when new events are characterized (i.e., steps 302-306), as represented by step 320.

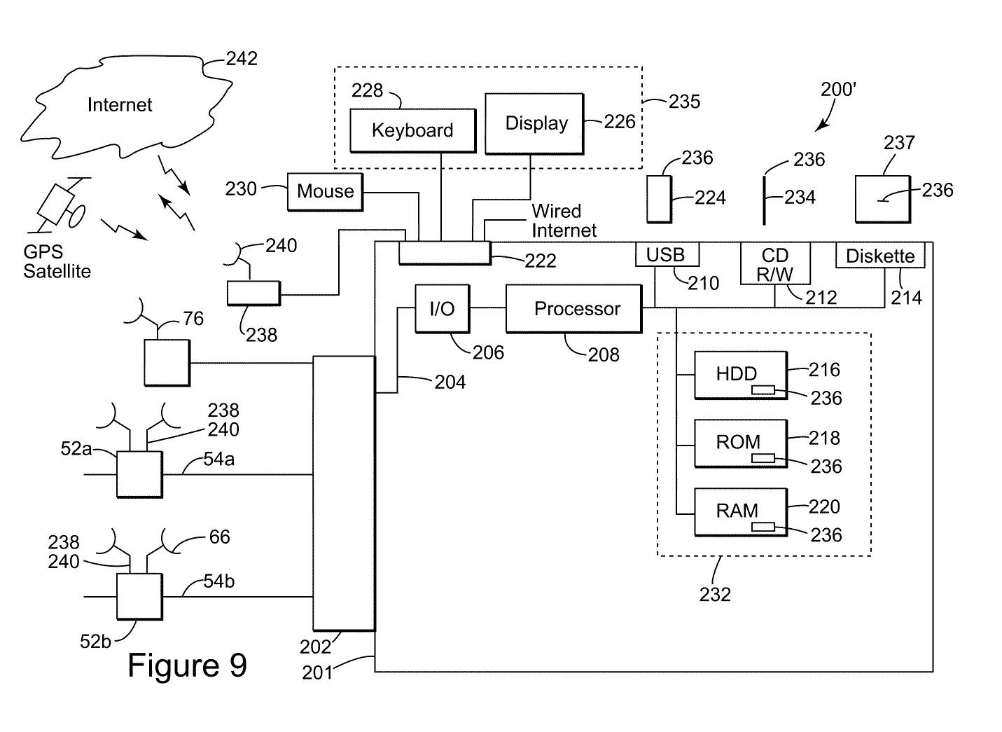

FIG. 9 illustrates a seismic data acquisition system (system) 200 suitable for use to implement a method for determining an average microseismic event and an absolute position of the average microseismic event for use in modeling future microseismic events and microseismic event clusters according to an exemplary embodiment. System 200 includes, among other items, server 201, microseismic sensor interface 202, internal data/communications bus (bus) 204, processor(s) 208 (those of ordinary skill in the art can appreciate that in modern server systems, parallel processing is becoming increasingly prevalent, and whereas a single processor would have been used in the past to implement many or at least several functions, it is more common currently to have a single dedicated processor for certain functions (e.g., digital signal processors) and therefore could be several processors, acting in serial and/or parallel, as required by the specific application), universal serial bus (USB) port 210, compact disk (CD)/digital video disk (DVD) read/write (R/W) drive 212, floppy diskette drive 214 (though less used currently, many servers still include this device), and data storage unit 232. Data storage unit 232 itself can comprise hard disk drive (HDD) 216 (these can include conventional magnetic storage media, but, as is becoming increasingly more prevalent, can include flash drive-type mass storage devices 224, among other types), ROM device(s) 218 (these can include electrically erasable (EE) programmable ROM (EEPROM) devices, ultra-violet erasable PROM devices (UVPROMs), among other types), and random access memory (RAM) devices 220. Usable with USB port 210 is flash drive device 224, and usable with CD/DVD R/W device 212 are CD/DVD disks 234 (which can be both read and write-able). Usable with diskette drive device 214 are floppy diskettes 237. Each of the memory storage devices, or the memory storage media (216, 218, 220, 224, 234, and 237, among other types), can contain parts or components, or in its entirety, executable software programming code (software) 236 that can implement part or all of the portions of the method described herein. Further, processor 208 itself can contain one or different types of memory storage devices (most probably, but not in a limiting manner, RAM memory storage media 220) that can store all or some of the components of software 236.

In addition to the above described components, system 200 also comprises user console 234, which can include keyboard 228, display 226, and mouse 230. All of these components are known to those of ordinary skill in the art, and this description includes all known and future variants of these types of devices. Display 226 can be any type of known display or presentation screen, such as liquid crystal displays (LCDs), light emitting diode displays (LEDs), plasma displays, cathode ray tubes (CRTs), among others. User console 235 can include one or more user interface mechanisms such as a mouse, keyboard, microphone, touch pad, touch screen, voice-recognition system, among other inter-active inter-communicative devices.

User console 234, and its components if separately provided, interface with server 201 via server input/output (I/O) interface 222, which can be an RS232, Ethernet, USB or other type of communications port, or can include all or some of these, and further includes any other type of communications means, presently known or further developed. System 200 can further include communications satellite/global positioning system (GPS) transceiver device 238, to which is electrically connected at least one antenna 240 (according to an exemplary embodiment, there would be at least one GPS receive-only antenna, and at least one separate satellite bi-directional communications antenna). System 200 can access internet 242, either through a hard wired connection, via I/O interface 222 directly, or wirelessly via antenna 240, and transceiver 238.

Server 201 can be coupled to other computing devices, such as those that operate or control the equipment of ship 2, via one or more networks. Server 201 may be part of a larger network configuration as in a global area network (GAN) (e.g., internet 242), which ultimately allows connection to various landlines.

According to a further exemplary embodiment, system 200, being ostensibly designed for use in seismic exploration, will interface with one or more microseismic sensors 52 via communications cable 54, or sensor data transmission system 66. In addition, one or more of microseismic sensors 52 can further include GPS transceiver/antenna 238/240, as discussed above.

According to further exemplary embodiments, user console 235 provides a means for personnel to enter commands and configuration into system 200 (e.g., via a keyboard, buttons, switches, touch screen and/or joy stick). Display device 226 can be used to show: streamer 6 position; visual representations of acquired data; source 4 and receiver 14 status information; survey information; and other information important to the seismic data acquisition process. Microseismic sensor interface 202 can receive microseismic data from microseismic sensor 52 though communication cable 54 and/or sensor data transmission system 66. Microseismic sensor interface 202 can also communicate bi-directionally with microseismic sensors 52 so that system 200 can monitor the condition of microseismic sensors 52.

Bus 204 allows a data pathway for items such as: the transfer and storage of data that originate from microseismic sensors 52; for processor 208 to access stored data contained in data storage unit memory 232; for processor 208 to send information for visual display to display 226; or for the user to send commands to system operating programs/software 236 that might reside in either the processor 208 or microseismic sensor interface 202.

System 200 can be used to implement method 300 for determining an average microseismic event and an absolute position of the average microseismic event for use in modeling future microseismic events and microseismic event clusters according to an exemplary embodiment. Hardware, firmware, software or a combination thereof may be used to perform the various steps and operations described herein. According to an exemplary embodiment, software 236 for carrying out the above discussed steps can be stored and distributed on multi-media storage devices such as devices 216, 218, 220, 224, 234, and/or 237 (described above) or other form of media capable of portably storing information (e.g., universal serial bus (USB) flash drive 426). These storage media may be inserted into, and read by, devices such as the CD-ROM drive 414, the disk drive 412, among other types of software storage devices.

According to an exemplary embodiment, implementation of method 300 can occur in a dedicated processor (not shown in either of FIGS. 1, 2, and 9). Those of ordinary skill in the art in the field of the invention can appreciate that such functionality can be designed into various types of circuitry, including, but not limited to field programmable gate array structures (FPGAs), application specific integrated circuitry (ASICs), microprocessor based systems, among other types. A detailed discussion of the various types of physical circuit implementations does not substantively aid in an understanding of the invention, and as such has been omitted for the dual purposes of brevity and clarity. However, as well known to those of ordinary skill in the art, the systems and methods discussed herein can be implemented as discussed, and can further include programmable devices.

Such programmable devices and/or other types of circuitry as previously discussed can include a processing unit, a system memory, and a system bus that couples various system components including the system memory to the processing unit. The system bus can be any of several types of bus structures including a memory bus or memory controller, a peripheral bus, and a local bus using any of a variety of bus architectures. Furthermore, various types of computer readable media can be used to store programmable instructions. Computer readable media can be any available media that can be accessed by the processing unit. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by the processing unit. Communication media can embody computer readable instructions, data structures, program modules or other data in a modulated data signal such as a carrier wave or other transport mechanism and can include any suitable information delivery media.

The system memory can include computer storage media in the form of volatile and/or nonvolatile memory such as read only memory (ROM) and/or random access memory (RAM). A basic input/output system (BIOS), containing the basic routines that help to transfer information between elements connected to and between the processor, such as during start-up, can be stored in memory. The memory can also contain data and/or program modules that are immediately accessible to and/or presently being operated on by the processing unit. By way of non-limiting example, the memory can also include an operating system, application programs, other program modules, and program data.

The processor can also include other removable/non-removable and volatile/nonvolatile computer storage media. For example, the processor can access a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive can be connected to the system bus through a non-removable memory interface such as an interface, and a magnetic disk drive or optical disk drive can be connected to the system bus by a removable memory interface, such as an interface.

The present invention can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs and generally optical data storage devices, magnetic tapes, flash drives, and floppy disks. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to, when implemented in suitable electronic hardware, accomplish or support exercising certain elements of the appended claims can be readily construed by programmers skilled in the art to which the present invention pertains.

The above-described exemplary embodiments are intended to be illustrative in all respects, rather than restrictive, of the present invention. Thus the present invention is capable of many variations in detailed implementation that can be derived from the description contained herein by a person skilled in the art. No element, act, or instruction used in the description of the present application should be construed as critical or essential to the invention unless explicitly described as such. Also, as used herein, the article “a” is intended to include one or more items.

We claim:

1. A method for analyzing microseismic events associated with hydraulic fracturing, the method comprising:
detecting a new microseismic event;
assigning the new microseismic event to a cluster;
determining a location of the new microseismic event relative to other microseismic events in the cluster;
translating an event location of each microseismic event in the cluster to a common location;
determining an average event in the cluster;
determining an absolute location of the average event;
determining a source mechanism of the average event; and
using the absolute location and the source mechanism of the average event to characterize a future microseismic event assigned to the cluster.

2. The method of claim 1, wherein the step of assigning further comprises:
comparing the new microseismic event with a reference event associated with each existing cluster; and
assigning the new microseismic event to a cluster whose reference event has a greatest similarity with the new microseismic event.

3. The method of claim 2, further comprising:
assigning the new microseismic event to the cluster whose reference event has the greatest similarity with the new microseismic event if the greatest similarity exceeds a first threshold.

4. The method of claim 3, further comprising:
assigning the new microseismic event to a new cluster if the greatest similarity is less than a second threshold.

5. The method of claim 2, wherein the step of comparing further comprises:
calculating an average correlation coefficient (CC) as:
$$CC ( Ei , Ej ) = max [ \frac{1}{N} {\sum }_{receivers} \frac{( {\sum }_{n} {S}_{i} ( n ) {S}_{j} ( n + t ) )}{\sqrt{( {\sum }_{n} {S}_{i} ( n ) {S}_{i} ( n + t ) ) ( {\sum }_{n} {S}_{j} ( n ) {S}_{j} ( n + t ) )}} ]$$
where:
Ei is the new microseismic event,
Ej is an existing cluster defined by the average of microseismic events belonging to this cluster;
Sᵢ (t) and Sⱼ (t) are waveforms corresponding to the microseismic event Ei and to the cluster Ej, respectively; and
N is a number of receivers used to record the waveforms.

6. A method for analyzing microseismic events associated with hydraulic fracturing, the method comprising:
detecting a new microseismic event;
assigning the new microseismic event to a cluster;
determining an average event in the cluster by determining a location of the new microseismic event relative to other microseismic events in the cluster and translating an event location of each microseismic event in the cluster to a common location; and
using the average event to characterize a future microseismic event assigned to the cluster.

7. The method of claim 6, wherein the step of assigning further comprises:
comparing the new microseismic event with the average event associated with each existing cluster; and
assigning the new microseismic event to a cluster whose average event has a greatest similarity with the new microseismic event.

8. The method of claim 7, further comprising:
assigning the new microseismic event to the cluster whose average event has the greatest similarity with the new microseismic event if the greatest similarity exceeds a first threshold.

9. The method of claim 8, further comprising:
assigning the new microseismic event to a new cluster if the greatest similarity is less than a second threshold.

10. The method of claim 7, wherein the step of comparing further comprises:
calculating an average correlation coefficient (CC) as:
$$CC ( Ei , Ej ) = max [ \frac{1}{N} {\sum }_{receivers} \frac{( {\sum }_{n} {S}_{i} ( n ) {S}_{j} ( n + t ) )}{\sqrt{( {\sum }_{n} {S}_{i} ( n ) {S}_{i} ( n + t ) ) ( {\sum }_{n} {S}_{j} ( n ) {S}_{j} ( n + t ) )}} ]$$
where:
Ei is the new microseismic event,
Ej is an existing cluster defined by the average of microseismic events belonging to this cluster;
Sᵢ (t) and Sⱼ (t) are waveforms corresponding to the microseismic event Ei and to the cluster Ej, respectively; and
N is a number of receivers used to record the waveforms.

11. A method for analyzing microseismic events associated with hydraulic fracturing, the method comprising:
detecting a new microseismic event;
assigning the new microseismic event to a cluster;
determining an average event in the cluster; and
using the average event to characterize a next detected microseismic event.

12. The method of claim 11, wherein the step of assigning further comprises:
comparing the new microseismic event with a reference event associated with each existing cluster; and
assigning the new microseismic event to a cluster whose reference event has a greatest similarity with the new microseismic event.

13. The method of claim 12, further comprising:
assigning the new microseismic event to the cluster whose reference event has the greatest similarity with the new microseismic event if the greatest similarity exceeds a first threshold.

14. The method of claim 13, further comprising:
assigning the new microseismic event to a new cluster if the greatest similarity is less than a second threshold.

15. The method of claim 12, wherein the step of comparing further comprises:
calculating an average correlation coefficient (CC) as:
$$CC ( Ei , Ej ) = max [ \frac{1}{N} {\sum }_{receivers} \frac{( {\sum }_{n} {S}_{i} ( n ) {S}_{j} ( n + t ) )}{\sqrt{( {\sum }_{n} {S}_{i} ( n ) {S}_{i} ( n + t ) ) ( {\sum }_{n} {S}_{j} ( n ) {S}_{j} ( n + t ) )}} ]$$
where:
Ei is the new microseismic event,
Ej is an existing cluster defined by the average of microseismic events belonging to this cluster;
Sᵢ (t) and Sⱼ (t) are waveforms corresponding to the microseismic event Ei and to the cluster Ej, respectively; and
N is a number of receivers used to record the waveforms.

16. The method of claim 12, wherein the reference event is the average event.

17. The method of claim 11, wherein the step of detecting further comprises:
detecting the new microseismic event by receiving a wave of seismic energy at one or more receivers disposed proximate ground.
